(19) United States
(12) Patent Application Publication
(10) Pub. No.: US 2016/0214875 A1
(43) Pub. Date: Jul. 28, 2016

(54) WATER TREATMENT SYSTEM

(71) Applicant: HITACHI, LTD., Tokyo (JP)

(72) Inventors: Shigeki TERUI, Tokyo (JP); Takashi YAMAGUCHI, Tokyo (JP); Yasuyuki YAGI, Tokyo (JP); Kiyokazu TAKEMURA, Tokyo (JP)

(73) Assignee: HITACHI, LTD., Tokyo (JP)

(21) Appl. No.: 15/025,397

(22) PCT Filed: Sep. 22, 2014
(86) PCT No.: PCT/JP2014/075026

§ 371 Date: Mar. 28, 2016

(30) Foreign Application Priority Data
Oct. 9, 2013 (JP) 2013-211662

(51) Int. Cl. C02F 1/72; C02F 1/76; C02F 1/78; C02F 1/66; C02F 1/00

(52) U.S. Cl. CPC C02F 1/722; C02F 1/66; C02F 1/008; C02F 1/78; C02F 1/76; C02F 2209/09; C02F 2301/024

(57) ABSTRACT

This water treatment system includes a water intake section 8 for taking in a raw water containing a water-soluble polymer; a stirring unit 1 for stirring the raw water flowing into the unit from the water intake section 8; a separating unit 2 for separating a solid from the raw water after the stirring; a viscosity measuring section (5,6,50) for measuring the viscosity of the raw water flowing in the stirring unit 1, and that of the raw water after the stirring; and a control unit 4 in which on the basis of a result measured through the viscosity measuring section and a predetermined target viscosity, a control is made about the amount of an additive to be charged into the stirring unit 1, and/or the stirring intensity of the stirring unit. Thus, the viscosity of the raw water is adjusted.

### TECHNICAL FIELD

The present invention relates to a water treatment system for separating a solid from a raw water containing a water-soluble polymer.

### BACKGROUND ART

When oil/gas are mined, a water discharged in association therewith is called produced water. Produced water contains therein inorganic solid components such as sand, oil components, and in accordance with a district where oil/gas are mined, the water contains salt, organic substances, heavy metals and others in a large proportion. About the produced water, therefrom, the solid components and the oil components are mainly removed; and subsequently the water is injected into the underground under pressure, or discharged into a river or the sea to be disposed of. The produced water may be reused as water for irrigation, or water for boilers by removing, besides the removal of these components, the salt, the organic substances, the heavy metals, and the others. As a technique for separating oil components from produced water, JP 2003-144805 A (Patent Document 1) is known. Patent Document 1 discloses a technique of emulsifying oil components in associated water and coagulating the oil components to be separated and removed.

In recent years, in order to recover and increase the production amount of oil/gas wells (production wells) in which the production amount has been decreased, enhanced oil recovery (EOR) has been performed. EOR is a technique of injecting various fluids from an injecting well located around a production well into the production well to promote the shift of oil/gas into the production well, thereby increasing the production amount of the oil/gas from the production well. Examples of a method for enhanced oil recovery include water flood of injecting water into a well to increase the pressure in its oil/gas phase, thermal recovery of injecting a heat source, such as steam, thereinto to lower the oil in viscosity to be heightened in fluidity, and chemical flood of injecting, for example, a surfactant thereinto to change the oil in interfacial tension to be heightened in fluidity.

In order to cause injected water to extend over a wide sphere in the underground to heighten the effect of forcing out oil/gas, in recent years, as a method of enhanced oil recovery, polymer flooding has been widely performed, in which a viscous water the viscosity of which is increased by an aqueous polymer is injected. Non-patent Document 1 (see below) discloses that a comparison is made between the production-amount-increase when water is used as injected water, and that when a viscous water composed of water and a polymer (aqueous polymer solution) is used as the same, and the production amount is increased when the viscous water is used. The polymer used therein is a polymer typical examples of which include saccharide and polyacrylamide.

### CITATION LIST

### Patent Document

Patent Document 1: JP 2003-144805 A

### Non-Patent Document

Non-patent Document 1: A comparison of 31 Minnelusa polymer floods with 24 Minnelusa water floods, Proceedings of SPE/DOE symposium on enhanced oil recovery, Vol. 7, (1990), pp. 557-566

### SUMMARY OF THE INVENTION

### Problem to be Solved by the Invention

However, in each of Patent Document 1 and Non-patent Document 1, no consideration is made about a point of adjusting the viscosity of a water-soluble polymer contained in a produced water collected, so as to separate a solid contained in the produced water effectively.

When an aqueous polymer solution is caused to flow into a separating apparatus for separating a solid from the solution in the state that the solution is high in viscosity, a bad effect is produced onto the separation or the like, which is based on specific gravity difference. In other words, in the high viscosity state, the solid is lowered in shift speed, so that the solid does not easily undergo an appropriate sedimentation separation.

Water-soluble polymer is used not only as the injected water but also as various articles, such as an agent for fiber-processing, a dispersant, an emulsifier, an agent for paper-making, and a water treatment coagulant. The above-mentioned problem may be caused in general industrial wastewater treatments.

An object of the present invention is to provide a water treatment system capable of separating a solid and others effectively from an aqueous polymer solution.

### Means for Solving the Problem

In order to solve the above-mentioned problem, the present invention is a water treatment system to be configured to include: a water intake section for taking in a raw water containing a water-soluble polymer; a stirring unit for stirring the raw water flowing into this unit from the water intake section; a separating unit for separating a solid from the raw water after the raw water is stirred; and a viscosity measuring section for measuring the viscosity of at least one of the raw water flowing in the stirring unit, and the raw water after the stirring; wherein on the basis of a result measured through the viscosity measuring section, a decision is made about at least one of the amount of an additive to be charged into the stirring unit, and the stirring intensity of the stirring unit.

### Advantageous Effects of the Invention

According to the present invention, a water treatment system can be provided in which the viscosity of an aqueous polymer solution is adjustable before a solid and others are separated from the solution, so as to attain the separation effectively.

Any object, structure and advantageous effect of the present invention other than those described above will be made clear through the description of embodiments thereof that will be demonstrated below.

### BRIEF DESCRIPTION OF THE DRAWINGS

FIG. 1 is a structural view of a water treatment system according to Embodiment 1 of the present invention.

FIG. 2 is a graph showing a relationship between the adding rate of an additive in an aqueous polymer solution and the viscosity of this solution.

FIG. 3 is a relationship chart between a period when an aqueous polymer solution is stirred, and the viscosity of this solution.

FIG. 4 is a flowchart of processing of a control unit in FIG. 1.

FIG. 5 is a structural view of a water treatment system according to Embodiment 2 of the present invention.

FIG. 6 is a structural view of a water treatment system according to Embodiment 3 of the present invention.

FIG. 7 is a structural view of a water treatment system according to Embodiment 4 of the present invention.

FIG. 8 is a schematic structural view of a static mixer in FIG. 6 or 7.

FIG. 9 is a schematic structural view of the static mixer in FIG. 6 or 7.

FIG. 10 is a schematic structural view of the static mixer in FIG. 6 or 7.

FIG. 11 is a structural view of a water treatment system according to Embodiment 5 of the present invention.

### DESCRIPTION OF THE EMBODIMENTS

Hereinafter, embodiments of the present invention will be described with reference to the attached drawings.

In the present specification, the wording “chemical viscosity decrease” is defined as a matter that a polymeric chain of a polymer is shrunken or decomposed by a chemical reaction of the polymer with an additive to decrease the viscosity of the polymer; and the wording “physical viscosity decrease”, as a matter that a polymeric chain of a polymer is cut by shear stress or some other to decrease the viscosity thereof.

In the specification, the following are called a line mixer and a static mixer, respectively: a mixer having a rotary member therein, this rotary member being driven from the outside of the mixer to apply shear force to a raw water flowing in the mixer; and a mixer having no rotary member therein to apply shear force to a raw water flowing in the mixer.

### Embodiment 1

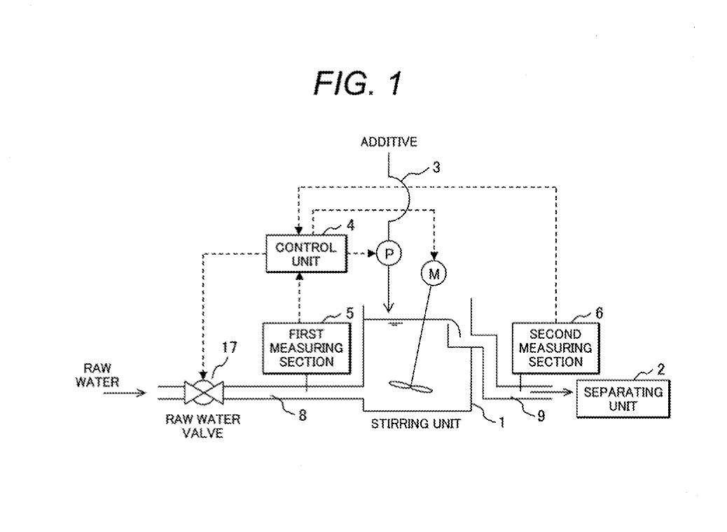

FIG. 1 is a structural view of a water treatment system according to Embodiment 1 of the present invention. The water treating system of the embodiment is composed of an additive charge section 3 in which one or more selected from oxidizers, metal salts, and pH adjusters are charged, as one or more additives, into an aqueous polymer solution that is a raw water; a stirring unit 1 for stirring the charged additive(s) and the aqueous polymer solution, as the raw water; a decomposing unit 2 for decomposing a solid from the raw water after the water is stirred; a first measuring section 5 for measuring the viscosity of the raw water; a second measuring section 6 for measuring the viscosity of the raw water after the stirring; and a control unit 4 for controlling the additive charge section 3 and the stirring unit 1. The raw water is passed through a raw water valve 17 to flow through a water intake pipe 8 to be sent into the stirring unit 1. The raw water after the stirring flows through a connecting pipe 9 to be sent into the separating unit 2. In FIG. 1, any one of the pipes is represented by a solid line; and any signal line or control line is represented by a dotted line.

The following will describe, as an example, a case where a water treatment system is used to treat produced water. The water treatment system of the present invention is applied not only any treatment of produced water but also other various treatments, such as seawater desalting treatment, domestic wastewater treatment, and industrial wastewater treatment.

A highly-viscous produced water is generated in shale-gas/oil mining spots, and oil/gas mining spots where enhanced oil recovery is performed by a polymer flooding method. In these spots, a water having a viscosity increased by a water-soluble polymer is injected into the underground. This polymer may be a polymeric typical examples of which include polysaccharide and polyacrylamide. Polysaccharide is a polymeric compound in which a large number of monosaccharide molecules are bonded to each other. Specific examples thereof include pectin, guar gum, xanthan gum, tamarind gum, carrageenan, propylene glycol, and carboxymethylcellulose, which are widely used also as food additives. Polyacrylamide is a polymer compound in which a large number of acrylamide molecules are bonded to each other, and is used also as a coagulant for wastewater treatment. The polymer is not limited to these species, and may be an appropriate species selected from all polymeric compounds and used in accordance with the state of an oil phase/gas phase into which the polymer is to be injected, and the usage thereof.

Next, a description will be made about chemical viscosity decrease based on the additive(s) from the additive charge section 3. An oxidizer is added to the aqueous polymer solution as the raw water, and then a mixed solution of the raw water and the oxidizer is stirred by means of the stirring unit 1. Inside a water tank of the stirring unit 1, the oxidizer and the raw water are mixed with each other and caused to react chemically with each other to decrease the viscosity of the aqueous polymer solution as the raw water (chemical viscosity decrease). The material of the water tank, which constitutes the stirring unit 1, is rendered a material having corrosion resistance and acid resistance. The shape thereof may be a rectangular or circular shape. In the case of the circular water tank, the mixing effect in the water tank is heightened by locating a baffle plate inside the water tank. The baffle plate is a plate arranged at a predetermined position of an inner wall of the circular water tank, and having a form projected toward the center of the water tank. A flow of the aqueous polymer solution that is generated by stirring-blades of the stirring unit 1 collides with this baffle plate to generate a turbulent flow. Thus, the effect of the mixing of the raw water with the oxidizer can be heightened. The stirring unit 1 used should be a unit having a capability of stirring the whole of the inside of the tank. The volume of the water tank, in which oxidization treatment is conducted by the addition of the oxidizer, is preferably a volume permitting the average retention period of the raw water to become at least one minute. When the raw water is a produced water, it is desired to render the water tank a sealed-up water tank which is not in contact with air, or make the water tank into an anaerobic state by purging the inside of the tank with an inert gas such as nitrogen in order to prevent a rise in the concentration of oxygen dissolved in the raw water. The reason therefor will be described as follows:

The oxidizer may be any one of ozone, hypochlorites, and hydrogen peroxide. In order to improve the oxidizing effect, a metal salt and/or a pH adjuster in addition with the oxidizer may be simultaneously, as the additive(s), to the raw water. However, hydrogen peroxide causes an increase in oxygen dissolved in the raw water. When the raw water is a produced water and a treated water thereof is reused as an injecting water, oxygen dissolved therein causes the propagation of bacteria which decompose oil/gas in the underground: thus, the treated water is required not to contain dissolved oxygen. Thus, when the raw water is a produced water and is reused as an injected water, it is desired to use an oxidizer other than hydrogen peroxide. In the case of using, as the oxidizer, sodium hypochlorite (NaClO), it is advisable to fit, to the additive charge section 3, a unit in which sodium hypochlorite is produced from salt water containing sodium chloride by the principle of electrolysis. When the raw water is a produced water, the water contains a large proportion of salts in many cases. Thus, sodium hypochlorite can be produced, using a treated water from which a solid has been separated from the raw water through the separating unit 2. When the water treatment system is established near the sea, seawater can be pumped up to be used. When the water treatment system of the present embodiment is arranged adjacently to seawater desalting equipment, a discharged water is usable, the water being discharged from its RO membrane vessel, which is a reverse osmosis membrane, and being high in salt concentration.

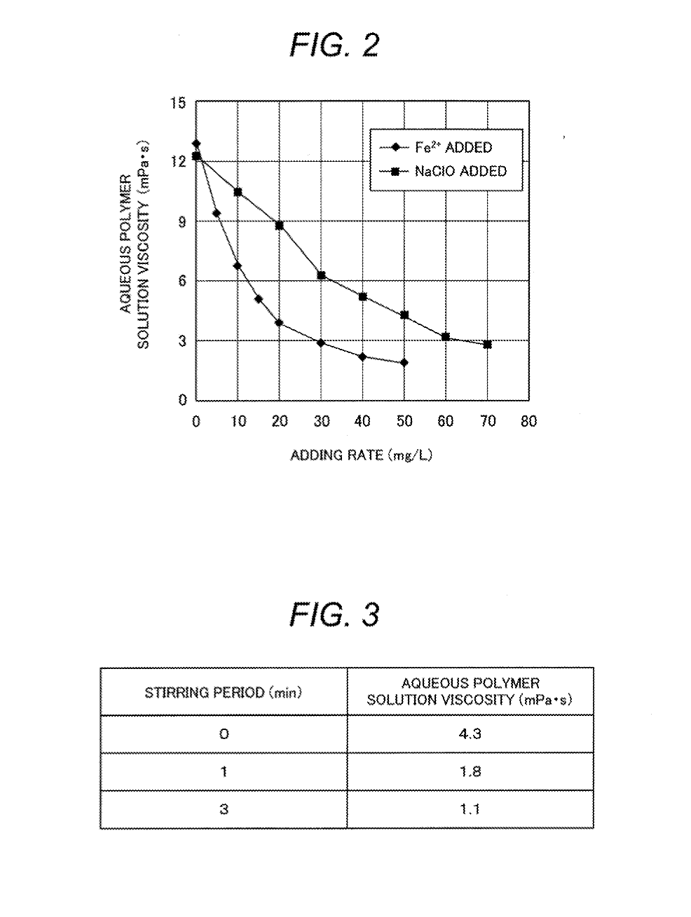

A description is described herein about a viscosity decreasing effect produced when sodium hypochlorite as the oxidizer is added to an aqueous solution of a polyacrylamide based polymer, and the resultant solution is stirred. FIG. 2 is a graph showing a relationship between the adding rate of the additives and the viscosity of the aqueous polymer solution. About conditions for the experiment, the concentration of the aqueous solution of a polyacrylamide based polymer was 1,000 mg/L, and the water temperature was 20° C. While the adding rate of sodium hypochlorite added to the aqueous polymer solution was varied, the viscosity (mPa·s) of the aqueous solution was measured. For the viscosity measurement, a cone plate type viscometer was used. FIG. 2 shows results obtained by plotting viscosities measured through the cone plate type viscometer under a condition that the rotation number of its cone type rotor was 100 rpm. As shown in FIG. 2, as the adding rate of sodium hypochlorite is increased, the viscosity of the aqueous polymer solution lowers. When the adding rate of sodium hypochlorite was 60 mg/L, the viscosity of the aqueous polymer solution was 3.2 mPa·s. When the adding rate was 70 mg/L, the viscosity of the aqueous polymer solution was 2.8 mPa·s. The viscosity of water is generally from 1.0 to 3.0 mPa·s both inclusive. In order to decrease the viscosity of the raw water to a value equivalent to that of water, it is sufficient for the adding rate of sodium hypochlorite to be set to 60 mg/L or more. Moreover, this viscosity decrease, down to be equivalent to the viscosity of water, can improve the effect of separating a solid (from the solution) after the decrease through the separating unit 2. About the polymer, active points which are present in the molecule thereof and have the same electric charges repel each other to spread its molecular chains, whereby the polymer is heightened in viscosity. Since the oxidizer inactivates the active points, the repellence based on the electric charges is lost so that the molecular chains are shrunken into a yarn-ball form. As a result, the polymer is lowered in viscosity (chemical viscosity decrease).

The adding rate of the oxidizer is largely varied in accordance with the viscosity of the raw water, a target viscosity of the resultant treated water, and the kind of the water-soluble polymer. Thus, it is desired to make a laboratory test beforehand to decide an oxidizer species producing a maximum viscosity decreasing effect onto the water-soluble polymer which is a target to be treated, and the adding rate thereof. Under the experimental conditions shown in FIG. 2, at an adding rate of 60 mg/L or more, the raw water is decreased to be substantially equal in viscosity to water. The pH, which is a reaction condition, is desirably from 2.0 to 10.0 both inclusive, more desirably from 4.0 to 8.0 both inclusive. Under the conditions shown in FIG. 2, the pH showed values in the range of 7.2 to 8.0.

In FIG. 2, shown is also a change in the viscosity of the aqueous polymer solution when a salt of a bivalent iron ion, which is a metal salt, was added, as an additive, to the solution. In the same manner as in the case of sodium hypochlorite, about conditions for the experiment, the concentration of the aqueous solution of a polyacrylamide based polymer was 1,000 mg/L, and the water temperature was 20° C. While the adding rate of bivalent iron ions added to the aqueous polymer solution was varied, the viscosity (mPa·s) of the aqueous polymer solution was measured at individual values of the adding rate. For the viscosity measurement, a cone plate type viscometer was used. As the adding rate is increased, the viscosity of the aqueous polymer solution lowers. When the adding rate of the bivalent iron ions was 30 mg/L, 40 mg/L, and 50 mg/L, the viscosity of the aqueous polymer solution was 2.9 mPa·s, 2.2 mPa·s, and 1.9 mPa·s, respectively. Accordingly, the adding rate is set to 30 mg/L or more, whereby the viscosity of the raw water can be decreased to a value equivalent to that of water. This way makes it possible to decrease the viscosity of the aqueous polymer solution down to be equivalent to the viscosity of water, thereby improving the effect of separating a solid (from the solution) through the separating unit 2.

FIG. 2 has showed the viscosity change of the aqueous polymer solution in the case of adding sodium hypochlorite, which is an oxidizer, and the bivalent iron ion, which is a metal salt ion, independently of each other. The viscosity decreasing effect is synergistically improved by adding, as the additive(s), sodium hypochlorite and the bivalent iron ion simultaneously. When the bivalent iron ion, which is a metal salt ion, is added simultaneously with the addition of hydrogen peroxide, hydroxy radicals (OH. and OOH.), which are strong in oxidizing power, are generated in accordance with chemical reactions shown below. Thus, the bivalent iron ion is favorably usable. A monovalent copper ion also acts in the same manner. Thus, the copper ion is favorably usable. A metal salt (ion) acts directly onto the above-mentioned active points, which the polymer molecule has therein, to produce an effect of inactivating the active points. Thus, only the metal salt may be added. The injection proportion of the metal salt, which is varied in accordance with the viscosity of the raw water and a target viscosity of the resultant treated water, is preferably from several milligrams per liter of the raw water to several hundred thousands of milligrams per liter thereof. In the case of the bivalent iron ion shown in FIG. 2, the proportion is desirably set to 30 mg/L or more. The kind of the metal salt ion is not limited to the iron ion nor copper ion. Thus, it is desired to select an optimal kind thereof beforehand through an experiment in accordance with the kind of the water-soluble polymer.

Fe²⁺+H₂O₂>Fe³⁺+OH.+OH⁻, and

Fe³⁺+H₂O₂>Fe²⁺+OOH.+H⁺

Next, a description will be made about physical viscosity decrease based on the stirring unit 1. The stirring blades of the stirring unit 1 are rotated at an outermost peripheral velocity of 0.5 to 20 m/s both inclusive, thereby giving a high shear force to a flow field inside the water tank of the stirring unit 1 (physical viscosity decrease). The form of the stirring blades may be a general-purpose form, such as the form of propeller blades, paddle blades, or turbine blades. The form is preferably a rotary body form having, on the outermost periphery thereof, projections each having an acute angle tip since the form induces a high shear force to the flow field. The G value of the stirring unit 1, which is an index of energy given to a fluid, is from several thousands (Ws) or more to several millions (1/s) or more. The G value is represented by the following equation:

$$\begin{matrix}[ Math . 1 ] & \\ G = \sqrt{\frac{{C}_{D} Σ ( Ai \cdot {v}^{3} )}{2 \cdot 𝓋 \cdot V}} & ( 1 )\end{matrix}$$

In the equation (1), ν is the kinetic viscosity (m²/s) of the fluid; V, the volume (m³) of the fluid; C_{D}, the resistance coefficient (dimensionless) of the stirring blades; Ai, the area (m³) of each of the blades; and v, the peripheral velocity of the blades (m/s). The peripheral velocity of the blades is represented by the following equation (2):

$$v = r \frac{2 \cdot π \cdot N}{60} \qquad ( 2 )$$

In the equation, r is the turning radius (m) of the blades, and N is the rotation number (rpm) of the blades. According to the equations (1) and (2), the G value increases in proportion to (the rotation number N)^{3/2}.

FIG. 3 is a relationship chart between the viscosity of an aqueous polymer solution and the period when the solution was stirred. About conditions for the experiment, in particular, about the structure of the stirring unit 1 for stirring a 300-mg/L solution of a polyacrylamide based polymer in water, the outside diameter of its stirring blades was 35 mm; the rotation number, 8000 rpm; the outermost peripheral velocity, 15 m/s; the volume to be treated with the unit, 1 L; and the G value, about 5000 (1/s). No additive was added thereto. Polymeric chains constituting the polymer are physically cut by shear stress based on the stirring, so that the molecular weight of the polymer is lowered to decrease the viscosity. As shown in FIG. 3, when the stirring period was 1 minute and 3 minutes, the viscosity of the aqueous polymer solution was 1.8 mPa·s, and 1.1 mPa·s, respectively. The viscosity of water is generally from 1.0 to 3.0 mPa·s both inclusive; thus, when the stirring period is set to 1 minute or more, the viscosity of the aqueous polymer solution can be decreased down to be equal to the viscosity of water, so that the effect of separating a solid (from the solution) through the separating unit 2 can be improved.

The stirring intensity is specified in accordance with the volume of the water tank of the stirring unit 1, the velocity of the stirring blades, and the stirring period. Since the volume of the water tank is fixed, the stirring intensity can be controlled in accordance with the velocity of the stirring blades, or the stirring period. In the present embodiment, the description has been made about the case where the stirring period is controlled. However, the velocity of the stirring blades may be controlled. In this case, the viscosity of the aqueous polymer solution can be decreased by increasing the rotation number of a motor for driving the stirring blades.

It is allowable to use, in addition to the physical viscosity decrease based on the stirring unit 1, an effect based on the addition of the above-mentioned additives) (one or more oxidizers, metal salts and/or pH adjusters). In this case, a higher viscosity decreasing effect can be gained by a synergetic effect of chemical viscosity decrease based on the additive(s) and the physical viscosity decrease based on the stirring unit 1.

Next, a description will be made about the first measuring section 5 for measuring the viscosity of the raw water at the upstream side of the stirring unit 1, and the second measuring section 6 for measuring the viscosity of the raw water at the downstream side of the stirring unit 1, that is, the viscosity of the raw water after the raw water is stirred.

It is sufficient for the first measuring section 5 and the second measuring section 6 to be each a commercially available in-line type viscosity viscometer. In the present embodiment, the first measuring section 5 is fitted to the raw water inflow part (water intake pipe 8) of the stirring unit 1; and the second measuring section 6, to the outflow part (connecting pope 9) of the stirring unit 1. Examples of the principle for measuring viscosity include capillary tube mode, vibrating mode, and rotating mode principles. A viscometer based on any one of these principles is favorably usable. When the period of a change in the viscosity is long, for example, the viscosity is changed in the unit of day, it is allowable to: collect the raw water from each of the measuring sections, for example, one time per day without using any in-line type viscometer; measure the viscosity thereof in a place such as a laboratory; and then adjust, on the basis of the result, the adding rate of the additive(s), or the stirring intensity of the stirring unit. When the viscosity is measured in such a place in this way, the above-mentioned cone plate type viscometer is favorably usable. In a case where the raw water is collected from each of the measuring sections and the viscosity thereof is measured in the place, the first and second measuring sections 5 and 6 correspond to spots where the raw water is collected, respectively. By measuring the viscosity of each of the collected raw waters without fitting any actual measuring section to the water treatment system, this case also produces the same effect and advantages produced when the measuring sections are fitted thereto. As the viscosity of the raw water flowing into the stirring unit 1 becomes higher, the torque of the stirring blades of the stirring unit 1 becomes larger, so that electric current flowing into the motor for driving the stirring blades becomes larger. It is therefore allowable to measure, in advance, a correlation between the viscosity of the raw water, and the torque of the motor or the electric current, and then measure the viscosity indirectly from the measured value of the torque or the electric current. Moreover, when the viscosity of the raw water becomes high, a pressure loss in the pipe in which the raw water flows is changed. It is therefore allowable to measure, in advance, a correlation between the viscosity of the raw water, and the pressure loss, and then measure the viscosity indirectly from a pressure value measured through a pressure gauge fitted to the above-mentioned pipe.

The following will describe the operation of the control unit 4. The control unit 4 has a CPU, and memories such as ROMs and RAMs, which are each not illustrated, and reads out programs memorized in the memories to attain various processing. In the memories is memorized the relationship shown in FIG. 2 between the respective adding rates of the oxidizer and the metal salt, as additives, and the viscosity of the aqueous polymer solution, which is a raw water. In the memories are also stored the relationship shown in FIG. 3 between the stirring period of the stirring unit and the viscosity of the aqueous polymer solution, and a relationship not illustrated between the velocity of the stirring blades of the stirring unit and the aqueous polymer solution. As a target viscosity, a value is also stored which is, for example, from 2.0 to 3.0 mPa·s both inclusive.

A description is made herein about the reason why the target viscosity value is set into the range of 2.0 to 3.0 mPa·s both inclusive. The viscosity of a produced water depends mainly on the water temperature thereof, and the salt concentration therein. The water temperature of the produced water and the salt concentration therein are largely varied in accordance with a district where oil/gas are mined. The water temperature is from 5 to 80° C. both inclusive, and the salt concentration is from 3.0 to 30% both inclusive in many cases. The viscosity shows a highest value when the water temperature is 5° C. and the salt concentration is 30%. At this time, the viscosity is 3 mPa·s. By contrast, the viscosity shows a lowest value when the water temperature is 80° C. and the salt concentration is 0% (fresh water). The viscosity is 0.3 mPa·s.

Accordingly, the viscosity of a produced water containing no water-soluble polymer is from 0.3 to 3.0 mPa·s both inclusive. Thus, in many cases, existing associated water treatment devices have been designed on the supposition that the produced water viscosity is 3.0 mPa·s or less. In the present embodiment, the target viscosity is set to a relative high value in this range, i.e., a value of 2.0 to 3.0 mPa·both inclusive. This is because the use amount of the additive(s) necessary for decreasing the viscosity can be saved by setting the target viscosity to the relative high value. Moreover, by setting the target viscosity to the relative high value, the use amount of the water-soluble polymer necessary for increasing the viscosity again can also be saved when the water that has been treated is reused for a polymer flooding method.

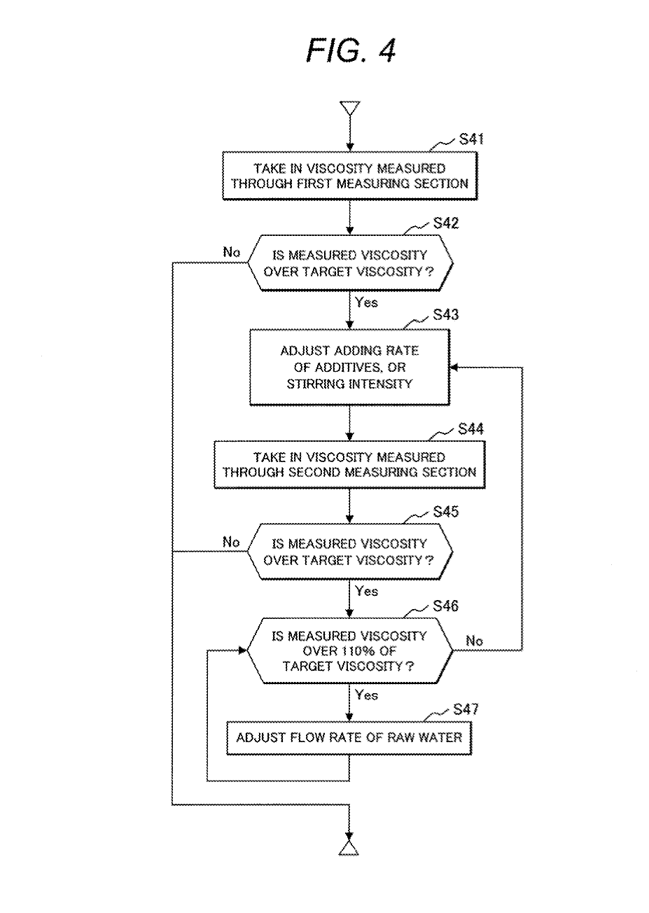

FIG. 4 is a flowchart of processing of the control unit in FIG. 1. The control unit 4 takes in the measured viscosity of a raw water (aqueous polymer solution) flowing into the stirring unit 1 through the first measuring section 5 (step S41). The unit 4 compares the taken-in measured viscosity with the target viscosity memorized in advance to determine whether or not the measured viscosity is over the target viscosity (step S42). As a result of the determination, when the measured viscosity is the target viscosity or less, the processing is ended. When the measured viscosity is over the target viscosity, the present processing is advanced to a next step.

In the next step, with reference to the relationship between the respective adding rates of the additives and the aqueous polymer solution viscosity, the relationship between the velocity of the stirring blades of the stirring unit and the aqueous polymer solution viscosity, and the relationship between the stirring period and the aqueous polymer solution viscosity, which are each stored in the memories, at least one of the following is carried out in accordance with a difference between the target viscosity and the measured viscosity (step S43): the adjustment of the adding rates of the additives; and the adjustment of the stirring intensity of the stirring unit. About the adjustment of the adding rates of the additives, the adding rates corresponding to the difference are calculated from the above-mentioned reference result, and the calculated adding rates are outputted, as command values, to the additive charge section 3. About the adjustment of the stirring intensity of the stirring unit, the stirring blade velocity corresponding to the difference is calculated from the reference result, and the calculated stirring blade velocity is outputted, as a command value, to the stirring unit 1. The stirring period is decided in accordance with the period when the raw-water remains in the stirring unit 1. Thus, the stirring period is usually made constant. However, the inflow rate of the raw water into the stirring unit 1 may be controlled through the raw water valve 17 to control the stirring period.

Next, from the second measuring section 6, the control unit 4 takes in the measured viscosity, that is, the measured viscosity of the raw water after the raw water is stirred (step S44). The control unit 4 compares the taken-in measured viscosity with the target viscosity memorized beforehand in the memories to determine whether or not the measured viscosity is over the target viscosity (step S45). As a result of the determination, when the measured viscosity is the target viscosity or less, the processing is ended. When the measured viscosity is over the target viscosity, the present processing is advanced to a next step.

In the next step, it is determined whether or not the measured viscosity is over 110% of the target viscosity (step S46). As a result of the determination, when the measured viscosity is 110% of the target viscosity, or less, at least one of the following is carried out in accordance with a difference between the measured viscosity and the target viscosity (step S43): the adjustment of the respective adding rates of the additives; and the adjustment of the stirring intensity of the stirring unit 1. When the measured viscosity is over 110% of the target viscosity, the processing is advanced to a next step. In the next step, the raw water valve 17 is narrowed down to decrease the amount of the raw water flowing into the stirring unit 1 temporarily, or stop the raw water temporarily until the measured viscosity through the second measuring section 6 reaches down to the target viscosity or less (step S47). As a result, the measured viscosity reaches to 110% of the target viscosity or less (step S46), at least one of the following is carried out in accordance with a difference between the measured viscosity and the target viscosity (step S43): the adjustment of the respective adding rates of the additives; and the adjustment of the stirring intensity of the stirring unit 1.

In the above-mentioned example, a criterion for the determination in the step S46 is set to 110% of the target viscosity. However, this numerical value may be set to 120% for the following reason: in general, when the viscosity of a raw water is over 4.0 mPa·s, in the afterward-located separating unit 2 the processing capability is remarkably lowered or fluctuated; however, the viscosity can be controlled not to be over 4.0 mPa·s through the step S47 not only when the determination criterion in the step S46 is set to 3.3 mPa·s, which is 110% of the target viscosity upper limit value, 3.0 mPa·s, but also when the determination criterion is set to 3.6 mPa·s, which is 120% of the target viscosity upper limit value, 3.0 mPa·s. The control unit 4 carries out steps from the step S41 to the step S47 in a predetermined period.

Although the target viscosity is set into the range of 2.0 to 3.0 mPa·s both inclusive, the target value of the viscosity may be set in accordance with the processing capability of the afterward-located separating unit 2. About a wastewater (raw water) having a viscosity of several tens of millipascal seconds to several hundreds of millipascal seconds, such a control makes it possible that the afterward-located separating unit 2 constantly exhibits an original processing capability thereof even when the viscosity fluctuates. Thus, a treated water good in water quality can be constantly obtained.

The present embodiment is configured to measure both of the viscosity of the raw water flowing into the stirring unit 1 and that of the raw water flowing out from the stirring unit 1. However, the water treatment system of the present invention may be configured to measure the viscosity of either one of the two.

Next, a description will be described about the separating unit 2. The separating unit 2 is preferably a separating unit using a difference in specific gravity between solid components and oil, and water to separate the former from the latter. Examples of the unit include a hydrocyclone using oil and water, which are different from each other in specific gravity to separate the two from each other; a corrugated plate interceptor (CPI) separator using an inclined plate having a corrugated cross section to separate solid components and oil simultaneously and effectively from water; a dissolved air floatation (DAF) separator in which fine air bubbles are caused to adhere onto solid components and oil to make the specific gravity thereof light, thereby floating these substances to be separated; and a coagulating sedimentation separator in which a coagulant is injected onto a raw water containing solid components and oil to coagulate particles of these substances to each other, thereby forming lumps called flocs, and then sedimenting the flocs by gravitation to be separated from the water. The separating unit 2 is not limited to these units, and may be a unit in any other form as far as the unit is a unit using a specific gravity difference to separate solid components and oil from water. In the present embodiment, the viscosity of the raw water (aqueous polymer solution) flowing into the separating unit 2 is controlled into the range of 2.0 to 3.0 mPa·s both inclusive by action of the stirring unit 1 or the additive charge section 3. Thus, even when the viscosity of the raw water fluctuates, solid components and oil can be separated therefrom stably at any time through the separating unit 2.

According to the present embodiment, the viscosity of a raw water flowing into the separating unit 2 can be decreased; thus, also from a raw water having a viscosity of several tens of millipascal seconds to several hundreds of millipascal seconds, solid components and oil therein can be certainly removed without increasing a treatable volume of existing equipment. Through the second measuring section 6, a treated water (raw water that has been stirred) discharged from the stirring unit 1 is measured about the viscosity thereof, and on the basis of the measurement result, the stirring unit 1 or the additive charge section 3 can be controlled. Thus, even the viscosity of the raw water fluctuates, solid components and oil therein can be stably removed. Accordingly, when the raw water is a produced water, a treated water therefrom, in which solid components and oil have been removed, can be favorably reused as an injecting water by configuring a pipe through which the treated water is discharged from the separating unit 2 to be connected to an injecting well for a gas field. However, when the treated water is reused for a polymer flooding method, it is necessary to incorporate a water-soluble polymer into the treated water to increase the viscosity thereof. As the viscosity of the treated water is higher, the necessary amount of the water-soluble polymer at this time is permissible to be smaller. Thus, when the treated water is reused for a polymer flooding method, the target viscosity in FIG. 4 is made as high as possible provided that the viscosity is 3.0 mPa·s or less, so as to conduct the treatment, thereby making it possible to save the use amount of the water-soluble polymer.

When the treated water is not reused as an injecting water, it is sufficient for the target viscosity to be set into an appropriate value from a relationship between the treating performance of the separating unit 2, and the use amount of the additive(s) and the stirring intensity. When the inflow rate of the raw water has, for example, no margin for the capacity of the separating unit 2, the target viscosity is made as low as a value of 0.3 to 1.0 mPa·s both inclusive, whereby a load onto the separating unit 2 can be made small. When the target viscosity is set on the basis of the viscosity result measured through the first measuring section 5, an appropriate control can be made about the treating performance of the separating unit 2, the use amount of the additive(s), and the stirring intensity. When the viscosity result measured through the first measuring section 5 is, for example, over 4.0 mPa·s, which generally lowers the treating capability of the afterward-located separating unit 2, the target viscosity is made as high as a value of 2.0 to 3.0 mPa·s both inclusive, whereby the use amount of the additive(s) can be saved, or the target viscosity can be attained only by stirring. Moreover, by making the target viscosity as low as a value of 0.3 to 1.0 mPa·s both inclusive, the treating capability of the separating unit 2 can be caused to have a margin. Furthermore, even when the viscosity result measured through the first measuring section 5 is 3.0 mPa·s or less, the target viscosity can be set to an appropriate value in the range of 0.3 to 3.0 mPa·s both inclusive, thereby making it possible to save the use amount of the additive(s), and gain a required separating performance through the adjustment of the stirring intensity.

### Embodiment 2

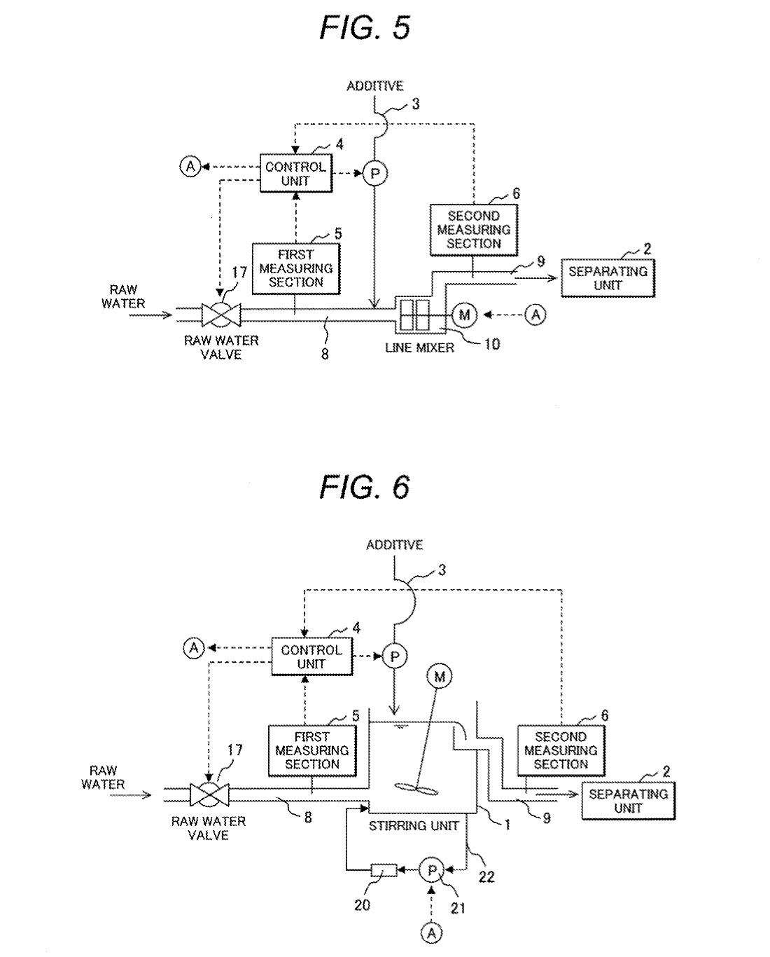

FIG. 5 is a structural view of a water treatment system according to Embodiment 2 of the present invention. In FIG. 5, the same reference numbers as in FIG. 1 are attached to the same constituents as in FIG. 1, respectively. The present embodiment is different from Embodiment 1 in that a line mixer 10 is used instead of the stirring unit 1.

The water treatment system has a water intake pipe 8 through which an aqueous polymer solution, which is a raw water, is taken in; a first measuring section 5 connected to the water intake pipe 8 to measure the viscosity of the raw water flowing into this section; the line mixer 10 connected to the water intake pipe 8 to apply shear stress to the raw water flowing into this mixer; a connecting pipe 9 through which the raw water discharged from the line mixer 10 is caused to flow into a separating unit 2; and a second measuring section 6 fitted to the connecting pipe 9 to measure the viscosity of the raw water discharged from the line mixer 10. This system also has an additive charge section 3 in which one or more additives are charged into the raw water flowing in the water intake pipe 8; and a control unit 4 for controlling the additive charge section 3 on the basis of the viscosity of the raw water flowing into the line mixer 10, which is measured through the first measuring section 5, and the viscosity of the raw water discharged from the line mixer 10, which is measured through the second measuring section 6. A rotary member inside the line mixer 10 is driven to be rotated through an outside motor.

In the same manner as in Example 1, the additive(s) charged through the additive charge section 3 is/are (each) any one of oxidizers, metal salts and pH adjusters, or a combination of two or more thereof. Thus, a description thereof is omitted herein.

The shear force applied to the raw water flowing in the line mixer 10 is decided in accordance with the driving power of the rotary member. In the present embodiment, the raw water viscosity is adjusted by controlling the driving power of the rotary member, i.e., the rotation number of the motor, and the adding rate of the additive(s). In the present embodiment, the control unit 4 is operated by adjusting at least one of the rotation number of the motor, and the adding rate of the additive(s) in the step S43 described with reference to the FIG. 4.

According to the present embodiment, the viscosity of the raw water flowing into the separating unit 2 can be decreased. Accordingly, from a discharged water having a viscosity of several tens of millipascal seconds to several hundreds of millipascal seconds, solid components and oil therein can be certainly removed without increasing a treatable volume of existing equipment. Moreover, through the second measuring section 6, the viscosity of the treated water (raw water that has been stirred) discharged from the line mixer 10 is measured, and on the basis of the measurement result, the driving power of the line mixer 10, and the additive charge section 3 can be controlled, so that solid components and oil therein can be stably removed even when the viscosity of the raw water fluctuates. Accordingly, when the raw water is a produced water, a treated water thereof, in which solid components and oil have been removed, can be favorably reused as an injecting water by configuring a pipe through which the treated water is discharged from the separating unit 2 to be connected to an injecting well for a gas field.

### Embodiment 3

FIG. 6 is a structural view of a water treatment system according to Embodiment 3 of the present invention. In FIG. 6, the same reference numbers as in FIGS. 1 and 2 are attached to the same constituents as in FIGS. 1 and 2, respectively. The present embodiment is different from Embodiment 1 in that the following are newly located: a circulating line 22 through which a raw water inside a stirring unit 1 is circulated; a static mixer 20 fitted to the circulating line 22; and a circulating pump 21.

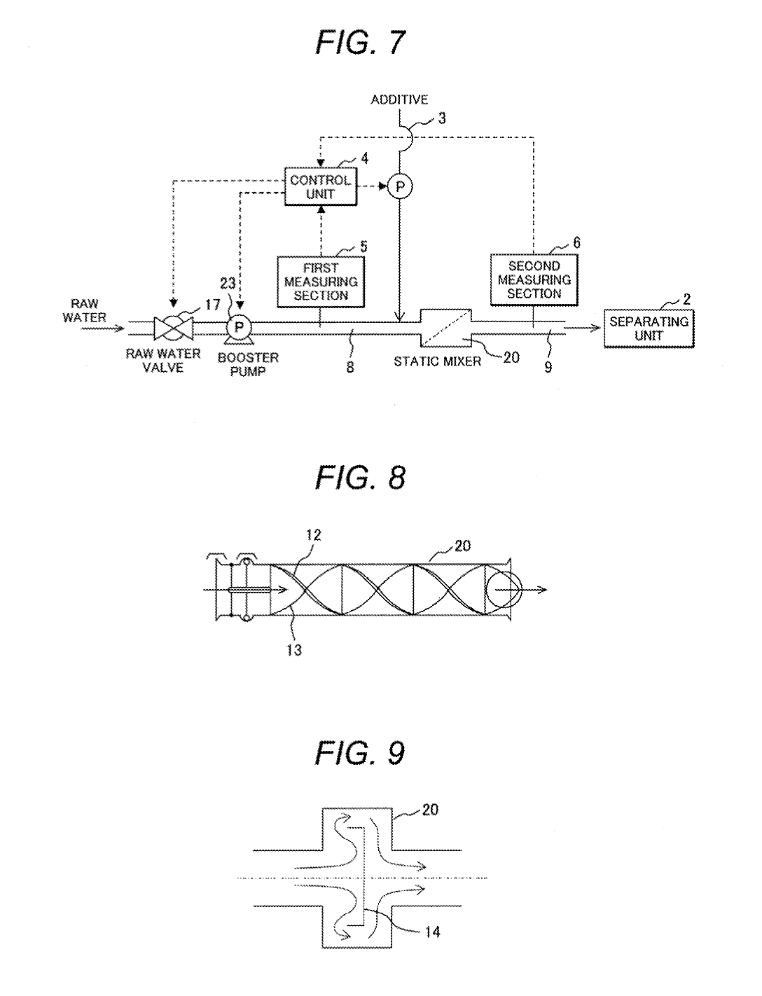

A description is made herein about the configuration of the static mixer 20. FIG. 8 is a schematic structural view of the static mixer illustrated in FIG. 6 or 7. In FIG. 8, the static mixer 20 has a first spiral fixed wing 12 and a second spiral fixed wing 13 that are opposite to each other inside a pipe over a region extending from its inflow part and outflow part. The raw water inside the stirring unit 1 illustrated in FIG. 6 is sent to the static mixer 20 by the circulating pump 21. The flow of the sent raw water is turned to reversely rotational flows by the individual spiral fixed wings 12 and 13. These rotational flows interfere with each other to apply shear stress to the raw water.

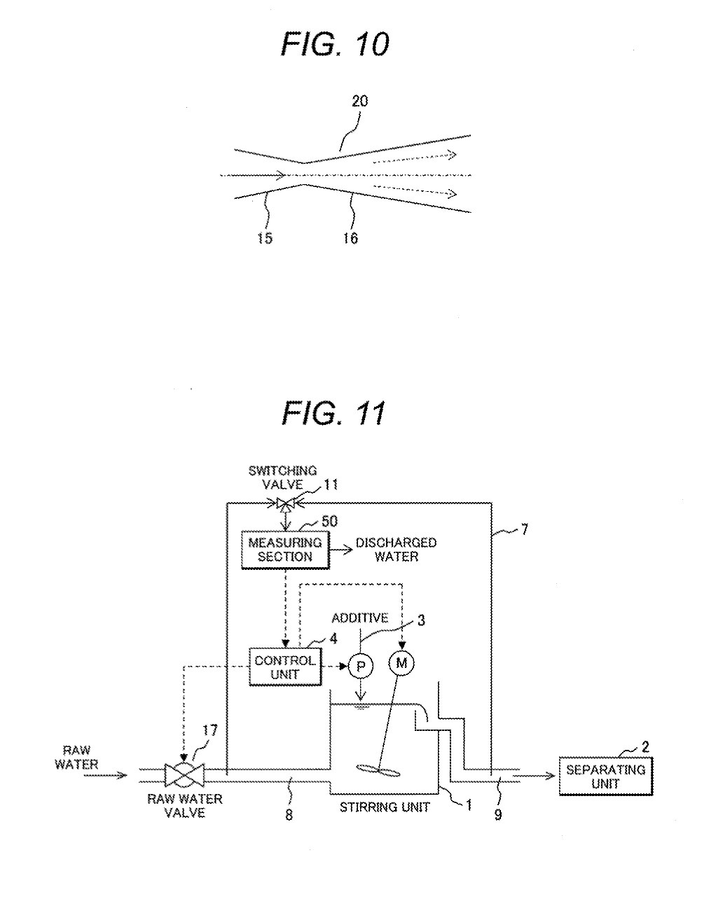

FIG. 9 illustrates another structure of the static mixer 20 in FIG. 6 or 7. In FIG. 9, the static mixer 20 has therein a dispersing member 14 in a disc form having an outer circumferential edge from which a projected structure is extended toward the direction of a fluid which flows into the mixer 20. The flow of the raw water sent into the static mixer 20 by the circulating pump 21 collides with the dispersing member 14, and passes in a gap between the outer circumferential edge of the dispersing member 14 and an inner wall thereof to flow to the downstream side of the system. The system is configured to apply shear stress to the raw water when the raw water flows in the gap. FIG. 10 is still another structure of the static mixer 20 in FIG. 6 or 7. In FIG. 10, the static mixer 20 has a structure equipped with a channel-width-narrowed region 15 and a channel-width-enlarged region 16. When the raw water sent into the static mixer 20 by the circulating pump 21 passes through the channel-width-narrowed region 15 to flow out toward the channel-width-enlarged region 16, shear stress is applied to the raw water by cavitation force.

In FIG. 6, the raw water viscosity is adjusted by controlling at least one of the flow rate of the circulated water, the adding rate of one or more additives, and the stirring intensity of the stirring unit 1. In the present embodiment, the control unit 4 is operated by adjusting at least one of the flow rate of the circulated water, the adding rate of the additive(s), and the stirring intensity in the step S43 described with reference to FIG. 4.

The raw water viscosity in the static mixer 20 is adjusted by adjusting the flow rate of the circulated water supplied into the static mixer 20. As the flow rate is larger, the shear stress applied to the raw water is larger. Thus, when the viscosity decreasing effect is desired to be made large, it is advisable to make a control for increasing the flow rate of the circulated water. In the present embodiment, physical viscosity decrease is performed by the static mixer 20. It is therefore sufficient for the decrease that a minimum stirring is continued without adjusting the stirring intensity of the stirring unit 1. In other words, the static mixer 20 and the stirring unit 1 take partial charge of the physical viscosity decrease. The partial charge ratio between the two can be appropriately set.

According to the present embodiment, the viscosity of the raw water flowing into the separating unit 2 can be decreased. Accordingly, from a discharged water having a viscosity of several tens of millipascal seconds to several hundreds of millipascal seconds, solid components and oil therein can be certainly removed without increasing a treatable volume of existing equipment. Moreover, through the second measuring section 6, the viscosity of the treated water (raw water that has been stirred) discharged from the stirring unit 1 is measured, and on the basis of the measurement result, the flow rate of the static mixer 20, the stirring unit 1, and the additive charge section 3 can be controlled, so that solid components and oil therein can be stably removed even when the viscosity of the raw water fluctuates. Accordingly, when the raw water is a produced water, a treated water thereof, in which solid components and oil have been removed, can be favorably reused as an injecting water by configuring a pipe through which the treated water is discharged from the separating unit 2 to be connected to an injecting well for a gas field.

### Embodiment 4

FIG. 7 is a structural view of a water treatment system according to Embodiment 4 of the present invention. In FIG. 7, the same reference numbers as in FIGS. 1 and 2 are attached to the same constituents as in FIGS. 1 and 2, respectively. The present embodiment is different from Embodiment 2 in that the system has a static mixer 20 and a booster pump 23.

The static mixer 20 may be any one of the mixers illustrated in FIGS. 8 to 10. It is sufficient for the static mixer 20 to be a mixer producing an expected viscosity decreasing effect at a predetermined raw water flow rate. As the raw water viscosity is larger, a pressure loss in the static mixer 20 is larger so that the predetermined raw water flow rate may not be obtained. Thus, the booster pump 23 is fitted to a water intake pipe 8 for sending the raw water to the static mixer 20. In the present embodiment, the raw water viscosity is adjusted by adjusting at least one of the raw water inflow rate through the booster pump 23 and the adding rate of one or more additive(s). In the step S43 described with reference to FIG. 4, at least one of the inflow rate of the raw water and the adding rate of the additive(s) is adjusted. As described above, the static mixer 20 may be a mixer producing an expected viscosity decreasing effect at a predetermined raw water flow rate; if the raw water viscosity rises more largely than supposed so that the viscosity measured through the second measuring section 6 is over a target viscosity, the adding rate of the additive(s) is adjusted.

According to the present embodiment, the viscosity of the raw water flowing into the separating unit 2 can be decreased. Accordingly, from a discharged water having a viscosity of several tens of millipascal seconds to several hundreds of millipascal seconds, solid components and oil therein can be certainly removed without increasing a treatable volume of existing equipment. Moreover, through the second measuring section 6, the viscosity of the treated water (raw water that has been stirred) discharged from the static mixer 20 is measured, and on the basis of the measurement result, the flow rate of the static mixer 20, and the additive charge section 3 can be controlled, so that solid components and oil therein can be stably removed even when the viscosity of the raw water fluctuates. Accordingly, when the raw water is a produced water, a treated water thereof, in which solid components and oil have been removed, can be favorably reused as an injecting water by configuring a pipe through which the treated water is discharged from the separating unit 2 to be connected to an injecting well for a gas field.

### Embodiment 5

FIG. 11 is a structural view of a water treatment system according to Embodiment 5 of the present invention. In FIG. 11, the same reference numbers as in Embodiment 1 are attached to the same constituents as in Embodiment 1, respectively. The present embodiment is different from Embodiment 1 in that a single measuring section 50 realizes not only a measuring section for measuring the viscosity of a raw water (aqueous polymer solution) flowing into a stirring unit 1, but also one for measuring the viscosity of the raw water flowing out from the stirring unit 1.

The water treatment system has a bypass channel 7 having two ends, one thereof being connected to a water intake pipe 8 through which the raw water is taken into the stirring unit 1, and the other being connected to a connecting pipe 9 through which the stirring unit 1 and a separating unit 2 are connected. This system also has a switching valve 11 for making a switch between an operation of causing the raw water branched from the water intake pipe 8 to flow into the measuring section 50, and an operation of causing the raw water branched from the connecting pipe 9 to flow into the measuring section 50. The raw water that has flowed in the measuring section 50 and then has been measured about the viscosity thereof is discharged through a water-discharging pipe.

By effect of the switching valve 11, the raw water which is to flow into the stirring unit 1 through the water intake pipe 8 is partially taken into the measuring section 50, and the measured viscosity of the raw water is taken into the control unit 4 (corresponding to the step S41 in FIG. 4). Additionally, by effect of the switching valve 11, the raw water which is to flow out from the stirring unit 1 through the connecting pipe 9 is partially taken into the measuring section 50, and the measured viscosity of the raw water that has been stirred is taken into the control unit 4 (corresponding to the step S44 in FIG. 4). The control unit 4 carries out the same steps S42, S43, S45 an S46 as in FIG. 4 in the same way as in Embodiment 1.

In the present embodiment, the number of viscosity measuring sections to be used can be made smaller than in Embodiment 1 to make the number of parts to be used smaller.

According to the present embodiment, the viscosity of the raw water flowing into the separating unit 2 can be decreased. Accordingly, from a discharged water having a viscosity of several tens of millipascal seconds to several hundreds of millipascal seconds, solid components and oil therein can be certainly removed without increasing a treatable volume of existing equipment. Moreover, through the second measuring section 50, the viscosity of the treated water (raw water that has been stirred) discharged from the stirring unit 1 is measured, and on the basis of the measurement result, the stirring unit 1 or the additive charge section 3 can be controlled, so that solid components and oil therein can be stably removed even when the viscosity of the raw water fluctuates. Accordingly, when the raw water is a produced water, a treated water thereof, in which solid components and oil have been removed, cars be favorably reused as an injecting water by configuring a pipe through which the treated water is discharged from the separating unit 2 to be connected to an injecting well for a gas field.

In each of Embodiments 1 to 5, a case where polyacrylamide is used as the water-soluble polymer has been described. However, polymer referred to also as polysaccharide also produces the same advantageous effects as produced by polyacrylamide by selecting an appropriate oxidizer or metal salt. For example, polysaccharide is widely used as a food additive, such as a thickener, a stabilizer, a gelatinizer or a sticker, as indicated as a thickening polyose in a food product. In order to adjust the food feeling and others of the product, a viscosity adjuster is used therein. In the water treatment system of the present invention, the use of such a viscosity adjuster makes it possible to treat stably a raw water containing polysaccharide as a water-soluble polymer.

The present invention is not limited to the above-mentioned embodiments, and includes various modified embodiments thereof. For example, the above-mentioned embodiments are each a system described in detail for describing the present invention to be easily understandable. Thus, the invention is not necessarily limited to any embodiment having all the constituents described in each of the embodiments. The constituents of some one of the embodiments of the invention may be partially substituted with one or more of the constituents of one or more of the other embodiments. To the constituents of some one of the embodiments of the invention may be added one or more of the constituents of one or more of the other embodiments. One or more parts of the constituents of anyone of the embodiments of the invention may be deleted. Moreover, to the part(s) may be added one or more of the constituents of one or more of the other embodiments, or the part(s) may be substituted with the constituent(s) under the same condition.

### REFERENCE SIGNS LIST

1: stirring unit
2: Separating unit
3: Additive charge section
4: Control unit
5: First measuring section
6: Second measuring section
7: Bypass channel
8: Water intake pipe
9: Connecting pipe
10: Line mixer
11: Switching valve
12: First spiral fixed wing
13: Second spiral fixed wing
14: Dispersing member
15: Channel-width-narrowed region
16: Channel-width-enlarged region
17: Raw water valve
20: Static mixer
21: Circulating pump
22: Circulating line
23: Booster pump

1. A water treatment system, comprising:
a water intake section for taking in a raw water containing a water-soluble polymer;
a stirring unit for stirring the raw water flowing into this unit from the water intake section;
a separating unit for separating a solid from the raw water after the raw water is stirred; and
a viscosity measuring section for measuring the viscosity of at least one of the raw water flowing in the stirring unit, and the raw water after the stirring,
wherein on the basis of a result measured through the viscosity measuring section, a decision is made about at least one of the amount of an additive to be charged into the stirring unit, and the stirring intensity of the stirring unit.

2. The water treatment system according to claim 1,
further comprising a control unit for controlling at least one of the amount of the additive to be charged into the stirring unit, and the stirring intensity of the stirring unit on the basis of the viscosity measured through the viscosity measuring section and a predetermined target viscosity.

3. The water treatment system according to claim 2,
wherein the viscosity measuring section comprises a first viscosity measuring section arranged at the upstream side of the stirring unit, and a second viscosity measuring section arranged at the downstream side of the stirring unit, and
the control unit decides at least one of the charge amount of the additive, and the stirring intensity of the stirring unit from a difference between the viscosity measured through the first viscosity measuring section, and the predetermined target viscosity, and a difference between the viscosity measured through the second viscosity measuring section, and the predetermined target viscosity.

4. The water treatment system according to claim 1,
wherein the additive to be charged into the stirring unit is one or more selected from the group of consisting of oxidizers, metal salts and pH adjusters.

5. The water treatment system according to claim 2,
wherein the additive to be charged into the stirring unit is one or more selected from the group of consisting of oxidizers, metal salts and pH adjusters.

6. The water treatment system according to claim 4,
wherein the selected oxidizer(s) is/are one or more selected from the group of consisting of ozone, hypochlorites, and hydrogen peroxide, and the selected metal salts) is/are one or more selected from the group of consisting of iron ion salts and copper ion salts.

7. The water treatment system according to claim 5,
wherein the selected oxidizer(s) is/are one or more selected from the group of consisting of ozone, hypochlorites, and hydrogen peroxide, and the selected metal salt(s) is/are one or more selected from the group of consisting of iron ion salts and copper ion salts.

8. The water treatment system according to claim 2,
wherein the control unit sets the target viscosity into the range of 0.3 to 3.0 mPa·s both inclusive, and compares the target viscosity with the measured viscosity or the measured viscosities.

9. The water treatment system according to claim 3,
wherein the control unit sets the target viscosity into the range of 0.3 to 3.0 mPa·s both inclusive, and compares the target viscosity with the measured viscosity or the measured viscosities.

10. A water treatment system, comprising:
a water intake pipe through which a raw water containing a water-soluble polymer is caused to flow;
a line mixer connected to the water intake pipe to apply shear stress to the raw water flowing into this mixer;
a separating unit for separating a solid from the raw water flowing out from the line mixer; and
a viscosity measuring section for measuring the viscosity of at least one of the raw water at the upstream side of the line mixer and the raw water at the downstream side thereof,
wherein on the basis of a result measured through the viscosity measuring section, a decision is made about at least one of the charge amount of an additive to be charged into the water intake pipe, and a driving force for the line mixer.

11. The water treatment system according to claim 10,
further comprising a control unit for controlling at least one of the charge amount of the additive, and the driving force for the line mixer on the basis of the viscosity measured through the viscosity measuring section and a predetermined target viscosity.

12. The water treatment system according to claim 11,
wherein the viscosity measuring section comprises a first viscosity measuring section arranged at the upstream side of the line mixer to measure the viscosity of the raw water, and a second viscosity measuring section arranged at the downstream side of the line mixer to measure the viscosity of the raw water after the raw water passes through the line mixer, and
the control unit controls at least one of the charge amount of the additive, and the driving force for the line mixer from a difference between the viscosity measured through the first viscosity measuring section, and the predetermined target viscosity, and a difference between the viscosity measured through the second viscosity measuring section, and the predetermined target viscosity.

13. A water treatment system, comprising:
a water intake pipe through which a raw water containing a water-soluble polymer is caused to flow;
an stirring unit for stirring the raw water flowing into this unit from the water intake pipe;
a circulating line for circulating the raw water in the stirring unit;
a static mixer fitted to the circulating line to apply shear stress to the raw water;
a separating unit for separating a solid from the raw water flowing out from the stirring unit; and
a viscosity measuring section for measuring the viscosity of at least one of the raw water flowing in the stirring unit, and the raw water flowing out from the stirring unit,
wherein on the basis of a result measured through the viscosity measuring section, a decision is made about at least one of the charge amount of an additive to be charged into the water intake pipe, the stirring intensity of the stirring unit, and the flow rate of the raw water flowing in the circulating line.

14. The water treatment system according to claim 13,
further comprising a control unit for controlling at least one of the charge amount of the additive, the stirring intensity of the stirring unit, and the flow rate of the raw water flowing in the circulating line on the basis of the viscosity measured through the viscosity measuring section and a predetermined target viscosity.

15. A water treatment system, comprising:
a water intake pipe through which a raw water containing a water-soluble polymer is caused to flow;
a static mixer connected to the water intake pipe to apply shear stress to the raw water flowing into the mixer;
a separating unit for separating a solid from the raw water flowing out from the static mixer;
a viscosity measuring section for measuring the viscosity of at least one of the raw water at the upstream side of the static mixer and the raw water at the downstream side thereof; and
an additive charge section arranged at the upstream side of the static mixer to charge an additive into the water intake pipe,
wherein on the basis of a result measured through the viscosity measuring section, a decision is made about at least one of the charge amount of the additive, and the flow rate of the raw water flowing into the static mixer.

16. The water treatment system according to claim 15,
further comprising a control unit for controlling at least one of the charge amount of the additive, and the flow rate of the raw water flowing in the static mixer on the basis of the viscosity measured through the viscosity measuring section and a predetermined target viscosity.

17. The water treatment system according to claim 10,
wherein one or more selected from the group of consisting of oxidizers, metal salts and pH adjusters are charged into the water intake pipe.

18. The water treatment system according to claim 13,
wherein one or more selected from the group of consisting of oxidizers, metal salts and pH adjusters are charged into the water intake pipe.

19. The water treatment system according to claim 15,
wherein one or more selected from the group of consisting of oxidizers, metal salts and pH adjusters are charged into the water intake pipe.

20. The water treatment system according to claim 17,
wherein the selected oxidizers) is/are one or more selected from the group of consisting of ozone, hypochlorites, and hydrogen peroxide, and the selected metal salt(s) is/are one or more selected from the group of consisting of iron ion salts and copper ion salts.

21. The water treatment system according to claim 18,
wherein the selected oxidizer(s) is/are one or more selected from the group of consisting of ozone, hypochlorites, and hydrogen peroxide, and the selected metal salt(s) is/are one or more selected from the group of consisting of iron ion salts and copper ion salts.

22. The water treatment system according to claim 19,
wherein the selected oxidizer(s) is/are one or more selected from the group of consisting of ozone, hypochlorites, and hydrogen peroxide, and the selected metal salt(s) is/are one or more selected from the group of consisting of iron ion salts and copper ion salts.

23. The water treatment system according to claim 11,
wherein the control unit sets the target viscosity into the range of 0.3 to 3.0 mPa·s both inclusive, and compares the target viscosity with the measured viscosity.

24. The water treatment system according to claim 14,
wherein the control unit sets the target viscosity into the range of 0.3 to 3.0 mPa·s both inclusive, and compares the target viscosity with the measured viscosity.

25. The water treatment system according to claim 16,
wherein the control unit sets the target viscosity into the range of 0.3 to 3.0 mPa·s both inclusive, and compares the target viscosity with the measured viscosity.

26. A water treatment system, comprising:
a water intake pipe through which a raw water containing a water-soluble polymer is caused to flow;
a stirring unit connected to the water intake pipe to stir the raw water;
a separating unit for separating a solid from the raw water after the raw water is stirred;
a viscosity measuring section;
a connecting pipe through which the stirring unit and the separating unit are connected to each other;
a bypass channel having an end connected to the water intake pipe and another end connected to the connecting pipe;
a switching valve fitted to the bypass channel to cause at least one of the raw water taken in through the water intake pipe, and the raw water which is, after the raw water is stirred, taken in through the connecting pipe; and
a control unit for controlling at least one of the amount of an additive to be charged into the stirring unit and the stirring intensity of the stirring unit on the basis of the viscosity measured through the viscosity measuring section and a predetermined target viscosity.
